(19) United States
(12) Patent Application Publication
(10) Pub. No.: US 2026/0058707 A1
(43) Pub. Date: Feb. 26, 2026

(54) REPORTING CHANNEL STATE INFORMATION FOR ANTENNA ARRAYS IN WIRELESS COMMUNICATION SYSTEMS

(71) Applicant: ZTE Corporation, Shenzhen (CN)

(72) Inventors: Yunlu Wang, Shenzhen (CN); Yijian Chen, Shenzhen (CN); Shujuan Zhang, Shenzhen (CN); Yuan Si, Shenzhen (CN); Mengnan Jian, Shenzhen (CN); Hongkang Yu, Shenzhen (CN)

(73) Assignee: ZTE Corporation, Shenzhen (CN)

(21) Appl. No.: 19/122,196

(22) PCT Filed: Dec. 28, 2022
(86) PCT No.: PCT/CN2022/142855

§ 371 Date: Apr. 17, 2025

(51) Int. Cl. H04B 7/06; H04W 72/21

(52) U.S. Cl. CPC H04B 7/0626; H04B 7/0639; H04W 72/21

(57) ABSTRACT

Methods, systems, and devices for reporting channel state information for antenna arrays in cellular networks. An example method of wireless communication may include determining, by a network node, a mapping between a first channel state information (CSI) parameter and a second CSI parameter, which is followed by transmitting, by the network node to a wireless device, at least one of the first CSI parameter or the second CSI parameter. In this example, the first CSI parameter may include at least one of: a codebook type selection parameter or a positive integer L indicative of a number of vectors associated with a precoding matrix, and the second CSI parameter may include a base vectors group selection parameter.

This application is a national stage filing under 35 U.S.C. § 371 of international application number PCT/CN2022/142855, filed Dec. 28, 2022. The contents of this application are incorporated herein by reference in its entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for reporting channel state information for communication devices that use antenna arrays. The described embodiments enable (a) selecting between Type I codebooks and Type II codebooks and (b) increasing the number of vectors that are used to form a precoding vector when implementing a Type II codebook.

In an example aspect, a method for wireless communication may include determining, by a wireless device, a first channel state information (CSI) parameter, and then reporting the first CSI parameter to a network node. In this example, the first CSI parameter may include at least one of: a codebook type selection parameter or a positive integer L indicative of a number of vectors associated with a precoding matrix.

In another example aspect, another method for wireless communication may include determining, by a wireless device, a mapping between a first channel state information (CSI) parameter and a second CSI parameter, and then reporting at least one of the first CSI parameter or the second CSI parameter to a network node. In this example, the first CSI parameter may include at least one of: a codebook type selection parameter or a positive integer L indicative of a number of vectors associated with a precoding matrix, and the second CSI parameter may include a base vectors group selection parameter.

In yet another example aspect, yet another method for wireless communication may include determining, by a network node, a mapping between a first channel state information (CSI) parameter and a second CSI parameter, and transmitting at least one of the first CSI parameter or the second CSI parameter to a wireless device. In this example, the first CSI parameter may include at least one of: a codebook type selection parameter or a positive integer L indicative of a number of vectors associated with a precoding matrix, and the second CSI parameter may include a base vectors group selection parameter.

In yet another example aspect, the above-described methods are embodied in the form of processor-executable code and stored in a non-transitory computer-readable storage medium. The code included in the computer readable storage medium when executed by a processor, causes the processor to implement the methods described in this patent document.

In yet another example embodiment, a device that is configured or operable to perform the above-described methods is disclosed.

The above and other aspects and their implementations are described in greater detail in the drawings, the descriptions, and the claims.

### BRIEF DESCRIPTION OF DRAWINGS

FIG. 1 is a plot of propagation vectors constituting base orthogonal vectors of an example near-field codebook.

FIGS. 2A and 2B are example visual representations of the generation of near-field codebooks using groups of orthogonal base vectors.

FIGS. 3-5 show example flowcharts for wireless communication.

FIG. 6 shows an example block diagram of a hardware platform that may be a part of a network device or a communication device.

FIG. 7 shows an example of wireless communication including a base station (BS) and user equipment (UE) based on some implementations of the disclosed technology.

### DETAILED DESCRIPTION

Existing channel state information (CSI) reporting implementations in 5G NR cellular networks typically use precoding codebooks (or simply, codebooks) to implement precoding with antenna arrays, and it is assumed that codebooks are designed for operating in far-field regimes. However, if two communicating devices are fairly close to each other, and there is significant bidirectional communication between them, the far-field assumption may be significantly compromised. Furthermore, communication between the two devices typically uses the same type of codebook and/or the same number of vectors used to form a precoding vector.

Embodiments of the disclosed technology advantageously enable the implementation of dynamic codebook selection. In an example, the described methods may switch between the type of codebook being used. Additionally, or alternatively, the number of vectors to form the precoding vector can be increased. Switching codebook types and/or the number of vectors used advantageously improves throughput and reduces bit/block error rates.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology, and may be used in wireless systems implementing other protocols.

### 1 the Near-Field and Far-Field Operating Regimes

When two wireless communication devices are near each other and are communicating with a high messaging frequency, it is assumed that they are operating in the near-field regime. The near-field regime is characterized by 0.62 (D³/λ)^{1/2}<rₘ<2D²/λ, where D is the aperture of the antenna array, λ is the wavelength, and rₘ is the distance between the observation point (e.g., the wireless device) and the antenna array (e.g., the base station). When operating in the near-field regime, the incident wave is not parallel for the different elements of the antenna array.

In contrast, an antenna array is assumed to be operating in the far-field regime when the incident beam is parallel for different elements of the antenna array. Assuming one wireless device (e.g., UE, mobile node, etc.) is at a point (r, θ) in polar coordinates and a uniform linear array with N elements is positioned coincident on the y-axis, then the distance between the wireless device and the n-th element of the antenna array, which is at coordinates (0, y), is given as dₙ(r, θ; y)=r−y sin θ. In this scenario, the propagation vector of the wireless device can be expressed as:

$$h ( r , θ ) = {[ {h}_{1} … {h}_{n} … {h}_{N} ]}^{T}$$

$${h}_{n} = {κ}_{n} exp ( - j \frac{2 π}{λ} {d}_{n} )$$

Herein, kₙ represents the free space attenuation. If the distances between the wireless device and the N elements of the antenna array are similar in magnitude, kₙ can be assumed to be a constant. If d is assumed to be the distance between two adjacent elements of the antenna array, then, under the constraint ∥h∥=1, an approximation of the far-field propagation vector can be written as:

$$h ( r , θ ) = {\frac{1}{\sqrt{N}} [ \begin{matrix}{e}^{- j \frac{2 π}{λ} r} & {e}^{- j \frac{2 π}{λ} ( r - dsin θ )} & … & {e}^{- j \frac{2 π}{λ} ( r - ( N - 1 ) dsin θ )}\end{matrix} ]}^{T} .$$

### 2 Type I Codebooks and Type II Codebooks

Current 5G NR implementations use two types of codebooks—a Type I codebook, wherein a single vector is used to represent the precoding vector of one layer of the UE, and a Type II codebook, wherein L vectors of the codebook are used to represent the precoding vector of one layer of the UE. For the Type II codebook, each of the L vectors is multiplied by a coefficient, and then the vectors are added together to represent the corresponding precoding vector. Type II codebooks typically provide better performance than Type I codebooks.

### 3 Examples of Dynamic Codebook Type and Dynamic L

In some embodiments, a wireless device can determine that it needs better performance (e.g., a higher data rate, a lower bit error rate), and will report to the base station (BS) that it is (a) changing its codebook type from Type I to Type II or (b) increasing the value of L when already using a Type II codebook.

In an example, there are three wireless devices, denoted U₁, U₂, and U₃, and the value of L is selected from the set {L₁, L₂}, where L₁<L₂. If Ur needs the best performance and U₃ has the greatest insensitivity to performance, U₃ will report to the BS that its precoding vectors should be represented using a Type I codebook, U₂ will report that its precoding vectors should be represented using a Type II codebook with L set to L₁, and Ur will report to the BS that its precoding vectors should be represented using a Type II codebook with L set to L₂.

### 4 Examples of Assigning the Same Set of Vectors to Different Layers

In some embodiments, a UE is configured to have two layers, denoted l₁ and l₂. In this embodiment, the same set of vectors can be used to represent the two columns of the precoding matrix corresponding to l₁ and l₂.

### 5 Examples of Assigning Different Sets of Vector to Different Layers

In some embodiments, a UE is configured to have two layers, denoted l₁ and l₂. In this embodiment, two sets of vectors can be separately selected for l₁ and l₂, and the weighted combination of these vectors is used to represent the two columns of the precoding matrix corresponding to l₁ and l₂. In an example, the two sets of vectors are identical. In another example, the two sets of vectors are different.

### 6 Examples of Using a Second CSI Parameter

In some embodiments, a UE is configured to report two CSI parameters, denoted i₁ and i₂, to the base station (BS). In this embodiment, the two CSI parameters are used to indicate which vectors are selected to represent one column of the precoding matrix corresponding to one layer of the UE and the weights of those vectors.

In an example, a Type II codebook is chosen to be applied and the number of vectors used to represent the precoding vector (L) is chosen to be 2. Then, the vectors that are used to represent one layer of the UE are selected from {h₁, h₂, h₃} with the corresponding values of i₁ being 1, 2, and 3, respectively, and i₁ being represented by 4 bits. The weights of the selected vectors are chosen from {w₁, w₂, w₃, w₄} with the corresponding values of i₂ being 1, 2, 3, and 4, respectively, and i₂ being represented by 4 bits. If {h₁, h₃} are selected and their weights are chosen as {w₂, w₄}, then the UE will report i₁=[1, 3] and i₂=[2, 4] to the BS. Herein, a characteristic of the second CSI parameter is based on the first CSI parameter.

### 7 Examples of Dividing the Channel State Information (CSI)

In some embodiments, when a UE reports CSI to a BS, the CSI is divided into two parts, denoted part 1 and part 2. In an example, the codebook type information and the value of L are included in part 1, and the selected base vectors and weighting coefficients are included in part 2.

### 8 Examples of a Near-Field Codebook

Assuming the notation in Section 1 for the propagation vector of the wireless device, an approximation of the near-field propagation vector can be written as:

$$h ( r , θ ) = {\frac{1}{\sqrt{N}} [ \begin{matrix}{e}^{- j \frac{2 π}{λ} r} & {e}^{- j \frac{2 π}{λ} ( r - dsin θ + \frac{{d}^{2} {cos}^{2} θ}{2 r} )} & … & {e}^{- j \frac{2 π}{λ} ( r - ( N - 1 ) dsin θ + \frac{{( N - 1 )}^{2} {d}^{2} {cos}^{2} θ}{2 r} )}\end{matrix} ]}^{T} .$$

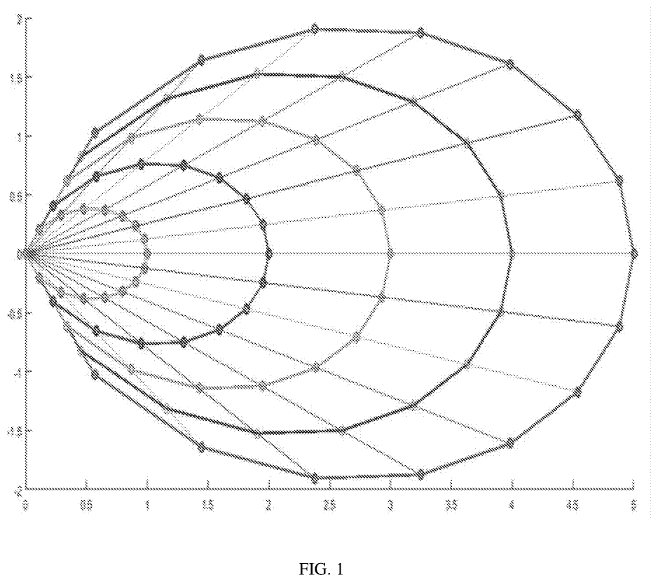

For the near-field embodiment, it is assumed that d=λ/2, and for two adjacent angles θ₁ and θ₂, N different directions are obtained by setting sin θ₁-sin θ₂=2/N. Setting (cos²θ)/2r=α, for a specific value of α, N different values of r are obtained in N different directions. The propagation vectors of these N points constitute a group of orthogonal base vectors. In this manner, c different values of α yield coordinates of c different groups of points in polar coordinates with each group having N points. The propagation vectors of these points constitute c groups of base orthogonal vectors of a near-field codebook. FIG. 1 provides a visual representation of a near-field codebook, where the propagation vectors of the points on a certain circle in the FIG. 1 constitute one set of base orthogonal vectors of the near-field codebook.

### 9 Examples of Type I and Type II Near-Field Codebooks

In some embodiments, a Type I near-field codebook includes using one vector of a codebook to represent the corresponding precoding vector of one layer of the UE. In order to improve performance for certain circumstances or operating conditions, each of L vectors in the same group of the codebook can be multiplied by a weighting coefficient and then added together to represent the corresponding precoding vector of one layer of the UE. This latter methodology generates the entries of a Type II near-field codebook.

### 10 Example of Near-Field Codebook Generation

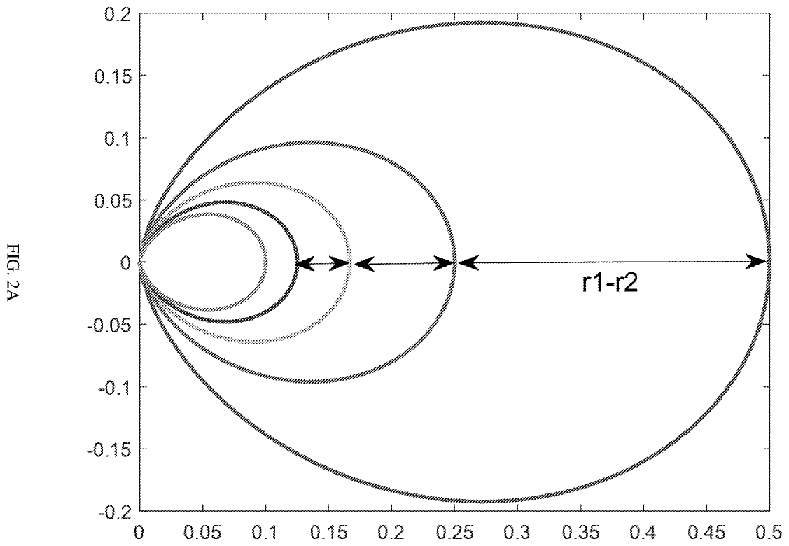

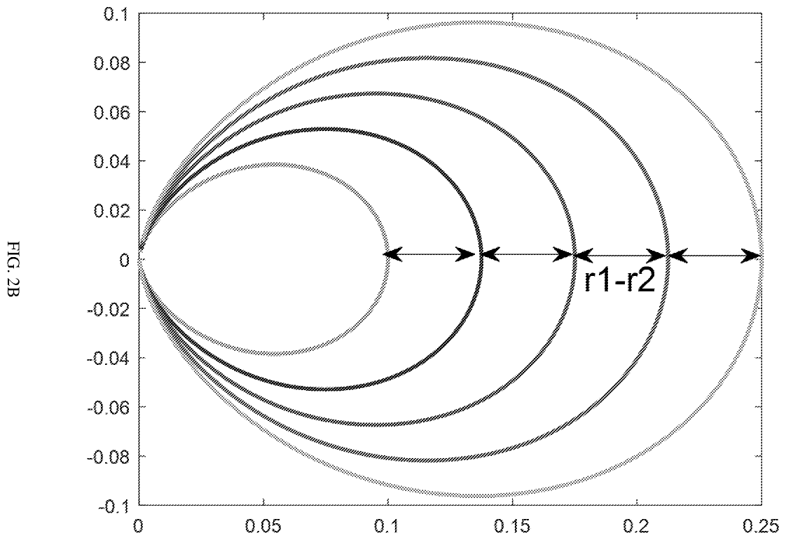

In some embodiments, the c groups of orthogonal base vectors of a near-field codebook are generated using the following operations:
Set d=λ/2;
For two adjacent angles θ₁ and θ₂, set sin θ₁−sin θ₂=2/N to obtain N different directions;
Set (cos²θ)/2r=α, and for a specific value of α, N different values of r are obtained in N different directions; and
Equally divide α into c parts, which results in c groups of orthogonal base vectors of a codebook with N orthogonal vectors each, where each vector is the propagation vector of a certain point in the near field. This example construction can be visually represented as shown in FIG. 2A, where the N points are on each circle and the propagation vectors of the points on a certain circle constitute one base orthogonal vectors of this codebook.

In this embodiment, each UE can select one group of base vectors to represent the corresponding precoding vector. Herein, the codebook is designed fairly for UEs in different zones of the near field, irrespective of how near or far the UEs are from the coordinate origin.

### 11 Another Example of Near-Field Codebook Generation

In some embodiments, the c groups of orthogonal base vectors of another near-field codebook are generated using the following operations:
Set d=λ/2;
For two adjacent angles θ₁ and θ₂, set sin θ₁−sin θ₂=2/N to obtain N different directions;
Set (cos²θ)/2r=α, and for a specific value of α, N different values of r are obtained in N different directions; and
Equally divide 1/a into c parts, which results in Δr=r₁−r₂ being a specific value. In this manner, c groups of orthogonal base vectors of a codebook with N orthogonal vectors each can be obtained, where each vector is the propagation vector of a certain point in the near field. This example construction can be visually represented as shown in FIG. 2B, where the N points are on each circle and the propagation vectors of the points on a certain circle constitute one base orthogonal vectors of this codebook.

In this embodiment, each UE can select one group of base vectors to represent the corresponding precoding vector. Herein, the codebook is designed such that UEs farther away from the coordinate origin have better performance than UEs nearer to the coordinate origin.

### 12 Examples of Dynamic Operation in Near-Field Regimes

As seen in the examples of near-field codebook construction in Sections 10 and 11, a near-field codebook could be fair or unfair for certain UEs in different zones of the near field based on how the coefficient α is divided to form the different groups of base orthogonal vectors of the codebook, i.e., how to divide the near field into different zones. Based on the division of α, different groups of the base orthogonal vectors can be formed. The precoding vector for each UE in the near field can be represented by one or more vectors in a group of base orthogonal vectors for a specific value of a, and there will be an optimal value of α for each UE in the near field.

In order to mitigate the fairness problem discussed in the context of Sections 10 and 11, UEs are configured to change their near-field codebook from a Type I near-field codebook to a Type II near-field codebook or increase the value of L if a Type II near-field codebook is already being used. Thus, in some embodiments, there is a relationship between the value of the coefficient α and the type of codebook and value of L.

In an example, the value of the coefficient α is selected from the set {α₁, α₂, α₃} and the value of L can be selected from the set {L₁, L₂}, where L₁<L₂. If the UE with ay as its best α value has the best performance and the UE with α₃ as its best α value has the worst performance, the UE with α₁ will report to the BS that its precoding vectors should be represented using a Type I near-field codebook, the UE with α₂ will report that its precoding vectors should be represented using a Type II codebook with L set to L₁, and the UE with α₃ will report to the BS that its precoding vectors should be represented using a Type II codebook with L set to L₂.

### 13 Examples of Operating with Codebook Type Reporting

In some embodiments, and in the context of FIG. 2B, UEs farther away from the coordinate origin have better performance than UEs closer to the coordinate origin. To mitigate the poorer performance in a UE closer to the coordinate origin, the UE is configured to report, to the BS, a change in the type of codebook from a Type I near-field codebook to a Type II near-field codebook or an increase in the value of L if a Type II near-field codebook is already being used. Alternatively, a UE that is moving closer to the coordinate origin can also report a change in the type of codebook or an increase in the value of L to compensate for the decreased performance as it nears the coordinate origin.

### 14 Examples of Operating with Near-Field Regime Coefficient Reporting

In some embodiments, and in the context of FIG. 2B, UEs farther away from the coordinate origin have better performance than UEs closer to the coordinate origin. To mitigate the poorer performance in a UE closer to the coordinate origin, the UE is configured to report, to the BS, the value of the coefficient α being used by the UE. In response to receiving the value of α being used by the UE, the BS is configured to change the type of codebook from a Type I near-field codebook to a Type II near-field codebook or increase in the value of L if a Type II near-field codebook is already being used.

### 15 Examples of Operation with Limited Groups of Orthogonal Base Vectors

In some embodiments, and in order to control the computational complexity and the amount of data transmitted from the UE to the BS, the number of the groups of orthogonal base vectors c, which determine how many parts the near field is divided into, is limited. However, a limited c implies a performance loss. To compensate for this performance loss, the BS is configured to change the type of codebook from a Type I near-field codebook to a Type II near-field codebook or increase in the value of L if a Type II near-field codebook is already being used, and inform this to the UE when the BS decides to set a small c.

In an example, the value of c is selected from the set {c₁, c₂, c₃} with c₁>c₂>c₃, and the value of L can be selected from the set {L₁, L₂}, where L₁<L₂. If the BS decides to use c₁ groups of orthogonal base vectors, it will choose a Type I near-field codebook and inform the UE of this choice. Similarly, if the BS decides to use c₂ groups of orthogonal base vectors, the selection of a Type II codebook with L set to L₁ is reported to the UE, and if the BS decides to use c₃ groups of orthogonal base vectors, the selection of a Type II codebook with L set to L₂ is reported to the UE.

### 16 Examples of Operation with Limited Frequency of Coefficient Feedback

In some embodiments, and in order to control the computational complexity and the amount of data transmitted from the UE to the BS, the UE is configured to calculate the optimal value for the coefficient α and report it to the BS with a required (appropriate) frequency. If the UE does not choose an optimal value for α and/or does not report it to the BS frequently enough, the UE may be required to report the most recently used identifier of the vectors to the BS, which may result in a performance loss. To compensate for this performance loss, when the BS is set to a low frequency of providing feedback to the UE, the BS is configured to change the type of codebook from a Type I near-field codebook to a Type II near-field codebook or increase in the value of L if a Type II near-field codebook is already being used.

In an example, the value of frequency of feedback (denoted f, and also referred to as the refresh frequency) of the optimal value of a is selected from the set {f₁, f₂, f₃} with f₁>f₂>f₃, and the value of L can be selected from the set {L₁, L₂}, where L₁<L₂. If the BS sets the frequency of feedback to f₁, it will choose a Type I near-field codebook and inform the UE of this choice. Similarly, if the BS sets the frequency of feedback to f₂, the selection of a Type II codebook with L set to L₁ is reported to the UE, and if the BS sets the frequency of feedback to f₃, the selection of a Type II codebook with L set to L₂ is reported to the UE.

### 17 Example Implementations of the Disclosed Technology

Embodiments of the disclosed technology provide, among others, the following technical solutions:

(1) A communication equipment is configured to inform another communication equipment about what kind of codebook it wants to use, e.g., whether the codebook uses one vector to represent one layer of its corresponding precoding vector (e.g., a Type I codebook) or the codebook uses multiple vectors of one group of base vectors to represent one layer of its corresponding precoding vector and how many vectors it wants to use (e.g., a Type II codebook).

(2) A communication equipment is configured to choose a group of base vectors to represents its corresponding precoding vectors, and the identifier of the group is used to determine which codebook type will be used, e.g., whether the codebook uses one vector to represent one layer of its corresponding precoding vector (e.g., a Type I codebook) or the codebook uses multiple vectors of one group of base vectors to represent one layer of its corresponding precoding vector and how many vectors it want to use (e.g., a Type II codebook).

(2.1) Multiple groups of vectors may be generated using the disclosed embodiments, and each communication equipment is configured to select one group of base vectors to represent the corresponding precoding vector. The performance of communication equipment with a certain group of base vectors might be worse than that of communication equipment with a different group of base vectors. To compensate for the performance loss of the former communication equipment, the type of codebook can be changed from a Type I codebook to a Type II codebook or the value of L (e.g., the number of vectors used to represent a precoding vector) can be increased if the Type II codebook is already being used.

(2.2) If the number of groups of base vectors is limited, and this number is less than a predetermined threshold, the type of codebook can be changed from a Type I codebook to a Type II codebook or the value of L (e.g., the number of vectors used to represent a precoding vector) can be increased if the Type II codebook is already being used.

(2.3) If the frequency of feedback, indicative of the group of base vectors in the codebook that is optimal for a communication equipment, is less than a predetermined threshold, the type of codebook can be changed from a Type I codebook to a Type II codebook or the value of L (e.g., the number of vectors used to represent a precoding vector) can be increased if the Type II codebook is already being used.

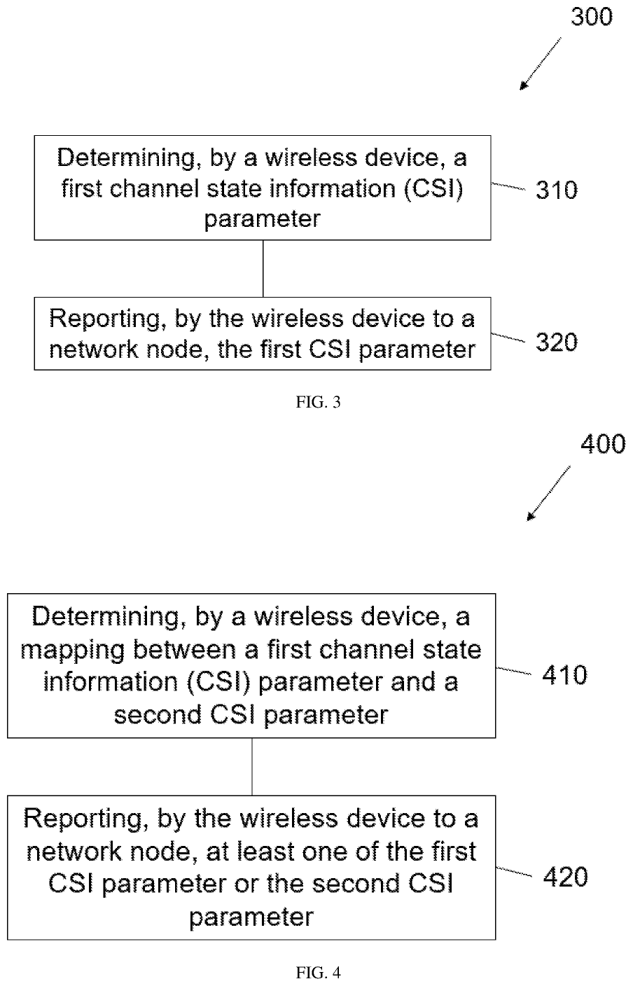

FIG. 3 shows an example flowchart for wireless communication. As shown therein, the method (300) includes determining, by a wireless device, a first channel state information (CSI) parameter (310), and reporting, by the wireless device to a network node, the first CSI parameter (320), wherein the first CSI parameter includes at least one of: a codebook type selection parameter or a positive integer L indicative of a number of vectors associated with a precoding matrix.

FIG. 4 shows another example flowchart for wireless communication. As shown therein, the method (400) includes determining, by a wireless device, a mapping between a first channel state information (CSI) parameter and a second CSI parameter (410), and reporting, by the wireless device to a network node, at least one of the first CSI parameter or the second CSI parameter (420), wherein the first CSI parameter includes at least one of: a codebook type selection parameter or a positive integer L indicative of a number of vectors associated with a precoding matrix, and wherein the second CSI parameter includes a base vectors group selection parameter.

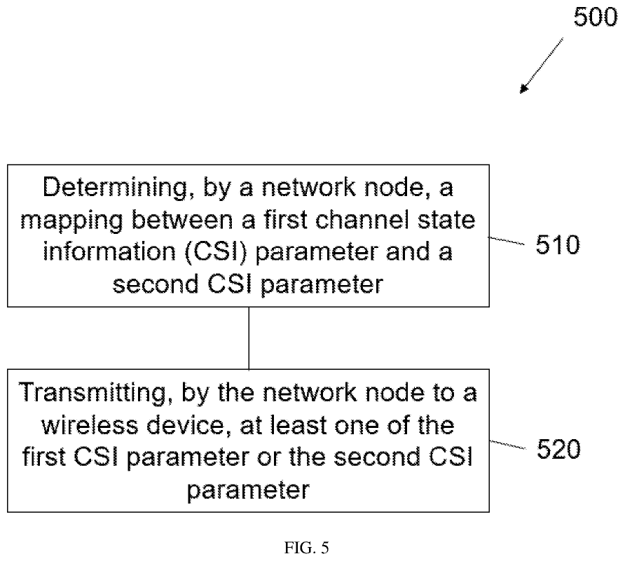

FIG. 5 shows another example flowchart for wireless communication. As shown therein, the method (500) includes determining, by a network node, a mapping between a first channel state information (CSI) parameter and a second CSI parameter (510), and transmitting, by the network node to a wireless device, at least one of the first CSI parameter or the second CSI parameter (520), wherein the first CSI parameter includes at least one of: a codebook type selection parameter or a positive integer L indicative of a number of vectors associated with a precoding matrix, and wherein the second CSI parameter includes a base vectors group selection parameter.

The disclosed technology further provides the following technical solutions:

1. A method of wireless communication, comprising: determining, by a wireless device, a first channel state information (CSI) parameter, wherein the first CSI parameter includes at least one of: a codebook type selection parameter or a positive integer L indicative of a number of vectors associated with a precoding matrix; and reporting, by the wireless device to a network node, the first CSI parameter.

2. The method of solution 1, wherein: when L is equal to 1, the precoding matrix is determined by the vector, and when L is greater than 1, the precoding matrix is determined by a weighted combination of the vectors, e.g., as described in Section 2.

3. The method of solution 1 or 2, wherein, when a number of layers supported by the wireless device is greater than 1, each column of the precoding matrix that corresponds to one layer is (a) a weighted combination of a same set of vectors or (b) a weighted combination of a respective set of vectors corresponding to the one layer, e.g., as described in Sections 4 and 5.

4. The method of solution 1, wherein the first CSI parameter is reported in a physical uplink control channel (PUCCH) or a physical uplink shared channel (PUSCH).

5. The method of solution 1, further comprising: reporting, by the wireless device to the network node, a second CSI parameter, wherein the second CSI parameter is based on the first CSI parameter, and wherein the second CSI parameter comprises at least one of an index of selected base vectors or one or more weighting coefficients for the selected base vectors, e.g., as described in Section 6.

6. The method of solution 5, wherein a characteristic of the second CSI parameter is based on the first CSI parameter, and wherein the characteristic comprises (a) a number of bits used to represent the second CSI parameter or (b) a codebook type rule followed by the second CSI parameter, e.g., as described in Section 6.

7. The method of solution 5 or 6, wherein the first CSI parameter is reported in a first part of a CSI report and the second CSI parameter is reported in a second part of the CSI report, e.g., as described in Section 7.

8. A method of wireless communication, comprising: determining, by a wireless device, a mapping between a first channel state information (CSI) parameter and a second CSI parameter; and reporting, by the wireless device to a network node, at least one of the first CSI parameter or the second CSI parameter, wherein the first CSI parameter includes at least one of: a codebook type selection parameter or a positive integer L indicative of a number of vectors associated with a precoding matrix, and wherein the second CSI parameter includes a base vectors group selection parameter.

9. The method of solution 8, wherein the mapping between the first CSI parameter and the second CSI parameter is determined further based on a received signaling or a rule.

10. A method of wireless communication, comprising: determining, by a network node, a mapping between a first channel state information (CSI) parameter and a second CSI parameter; and transmitting, by the network node to a wireless device, at least one of the first CSI parameter or the second CSI parameter, wherein the first CSI parameter includes at least one of: a codebook type selection parameter or a positive integer L indicative of a number of vectors associated with a precoding matrix, and wherein the second CSI parameter includes a base vectors group selection parameter.

11. The method of solution 10, wherein the mapping between the first CSI parameter and the second CSI parameter is determined further based on a received report or a rule.

12. The method of solution 9 or 11, wherein the mapping between the first CSI parameter and the second CSI parameter based on the rule comprises at least one of: (a) a predetermined mapping table between multiple values of the first CSI parameter and multiple values of the second CSI parameter; (b) a first value of the codebook type selection parameter of the first CSI parameter associated with a first value of the second CSI parameter determining a codebook to be a Type II codebook, and a second value of the codebook type selection parameter of the first CSI parameter associated with a second value of the second CSI parameter determining the codebook to be a Type I codebook, wherein the first value of the second CSI parameter is greater than the second value of the second CSI parameter; (c) a first value of L of the first CSI parameter associated with a first value of the second CSI parameter being greater than a second value of L of the first CSI parameter associated with a second value of the second CSI parameter, wherein the first value of the second CSI parameter is greater than the second value of the second CSI parameter; (d) a first number of available groups of base vectors associated with the second CSI parameter determining a codebook to be a Type II codebook and a second number of available groups of base vectors associated with the second CSI parameter determining the codebook to be a Type I codebook, wherein the first number is less than the second number, e.g., as described in Section 15; (c) a first value of L determined by the first number of available groups of base vectors associated with the second CSI parameter being greater than a second value of L determined by the second number of available groups of base vectors associated with the second CSI parameter, wherein the first value is less than the second value, e.g., as described in Section 15; (f) a first refresh frequency of the second CSI parameter determining a codebook to be a Type II codebook and a second refresh frequency of the second CSI parameter determining the codebook to be a Type I codebook, wherein the first refresh frequency is less than the second refresh frequency, e.g., as described in Section 16; or (g) a first value of L determined by a first refresh frequency of the second CSI parameter being greater than a second value of L determined by a second refresh frequency of the second CSI parameter, wherein the first refresh frequency is less than the second refresh frequency, e.g., as described in Section 16.

13. An apparatus for wireless communication comprising a processor, configured to implement the method recited in one or more of solutions 1 to 12.

14. A non-transitory computer readable program storage medium having code stored thereon, the code, when executed by a processor, causing the processor to implement the method recited in one or more of solutions 1 to 12.

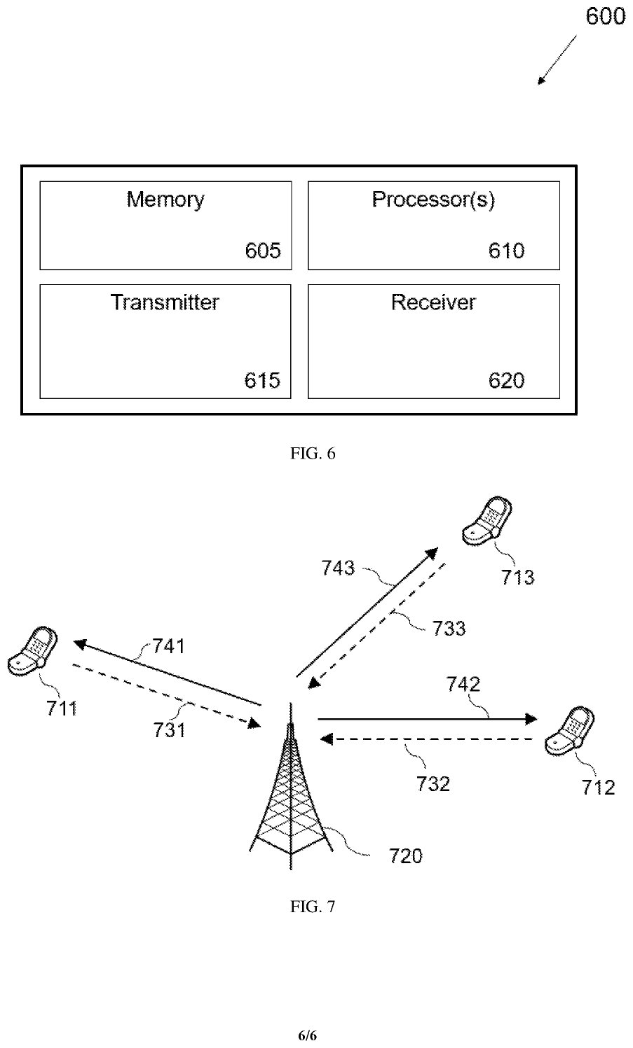

FIG. 6 shows an example block diagram of a hardware platform 600 that may be a part of a network device (e.g., base station) or a communication device (e.g., a user equipment (UE)). The hardware platform 600 includes at least one processor 610 and a memory 605 having instructions stored thereupon. The instructions upon execution by the processor 610 configure the hardware platform 600 to perform the operations described in FIGS. 3 to 5 and in the various embodiments described in this patent document. The transmitter 615 transmits or sends information or data to another device. For example, a network device transmitter can send a message to a user equipment. The receiver 620 receives information or data transmitted or sent by another device. For example, a user equipment can receive a message from a network device.

The implementations as discussed above will apply to a wireless communication. FIG. 7 shows an example of a wireless communication system (e.g., a 5G or NR cellular network) that includes a base station 720 and one or more user equipment (UE) 711, 712 and 713. In some embodiments, the UEs access the BS (e.g., the network) using a communication link to the network (sometimes called uplink direction, as depicted by dashed arrows 731, 732, 733), which then enables subsequent communication (e.g., shown in the direction from the network to the UEs, sometimes called downlink direction, shown by arrows 741, 742, 743) from the BS to the UEs. In some embodiments, the BS send information to the UEs (sometimes called downlink direction, as depicted by arrows 741, 742, 743), which then enables subsequent communication (e.g., shown in the direction from the UEs to the BS, sometimes called uplink direction, shown by dashed arrows 731, 732, 733) from the UEs to the BS. The UE may be, for example, a smartphone, a tablet, a mobile computer, a machine to machine (M2M) device, an Internet of Things (IoT) device, and so on.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method of wireless communication, comprising:
determining, by a wireless device, a first channel state information (CSI) parameter,
wherein the first CSI parameter includes at least one of: a codebook type selection parameter or a positive integer L indicative of a number of vectors associated with a precoding matrix; and
reporting, by the wireless device to a network node, the first CSI parameter.

2. The method of claim 1, wherein:
when L is equal to 1, the precoding matrix is determined by the vector, and
when L is greater than 1, the precoding matrix is determined by a weighted combination of the vectors.

3. The method of claim 1, wherein, when a number of layers supported by the wireless device is greater than 1, each column of the precoding matrix that corresponds to one layer is (a) a weighted combination of a same set of vectors or (b) a weighted combination of a respective set of vectors corresponding to the one layer.

4. The method of claim 1, wherein the first CSI parameter is reported in a physical uplink control channel (PUCCH) or a physical uplink shared channel (PUSCH).

5. The method of claim 1, further comprising:
reporting, by the wireless device to the network node, a second CSI parameter,
wherein the second CSI parameter is based on the first CSI parameter, and wherein the second CSI parameter comprises at least one of an index of selected base vectors or one or more weighting coefficients for the selected base vectors.

6. The method of claim 5, wherein a characteristic of the second CSI parameter is based on the first CSI parameter, and wherein the characteristic comprises (a) a number of bits used to represent the second CSI parameter or (b) a codebook type rule followed by the second CSI parameter.

7. The method of claim 5, wherein the first CSI parameter is reported in a first part of a CSI report and the second CSI parameter is reported in a second part of the CSI report.

8. A method of wireless communication, comprising:
determining, by a wireless device, a mapping between a first channel state information (CSI) parameter and a second CSI parameter; and
reporting, by the wireless device to a network node, at least one of the first CSI parameter or the second CSI parameter,
wherein the first CSI parameter includes at least one of: a codebook type selection parameter or a positive integer L indicative of a number of vectors associated with a precoding matrix, and wherein the second CSI parameter includes a base vectors group selection parameter.

9. The method of claim 8, wherein the mapping between the first CSI parameter and the second CSI parameter is determined further based on a received signaling or a rule.

10. A method of wireless communication, comprising:
determining, by a network node, a mapping between a first channel state information (CSI) parameter and a second CSI parameter; and
transmitting, by the network node to a wireless device, at least one of the first CSI parameter or the second CSI parameter,
wherein the first CSI parameter includes at least one of: a codebook type selection parameter or a positive integer L indicative of a number of vectors associated with a precoding matrix, and wherein the second CSI parameter includes a base vectors group selection parameter.

11. The method of claim 10, wherein the mapping between the first CSI parameter and the second CSI parameter is determined further based on a received report or a rule.

12. The method of claim 9, wherein the mapping between the first CSI parameter and the second CSI parameter based on the rule comprises at least one of:
(a) a predetermined mapping table between multiple values of the first CSI parameter and multiple values of the second CSI parameter;
(b) a first value of the codebook type selection parameter of the first CSI parameter associated with a first value of the second CSI parameter determining a codebook to be a Type II codebook, and a second value of the codebook type selection parameter of the first CSI parameter associated with a second value of the second CSI parameter determining the codebook to be a Type I codebook, wherein the first value of the second CSI parameter is greater than the second value of the second CSI parameter;
(c) a first value of L of the first CSI parameter associated with a first value of the second CSI parameter being greater than a second value of L of the first CSI parameter associated with a second value of the second CSI parameter, wherein the first value of the second CSI parameter is greater than the second value of the second CSI parameter;
(d) a first number of available groups of base vectors associated with the second CSI parameter determining a codebook to be a Type II codebook and a second number of available groups of base vectors associated with the second CSI parameter determining the codebook to be a Type I codebook, wherein the first number is less than the second number;
(e) a first value of L determined by the first number of available groups of base vectors associated with the second CSI parameter being greater than a second value of Z determined by the second number of available groups of base vectors associated with the second CSI parameter, wherein the first value is less than the second value;
(f) a first refresh frequency of the second CSI parameter determining a codebook to be a Type II codebook and a second refresh frequency of the second CSI parameter determining the codebook to be a Type I codebook, wherein the first refresh frequency is less than the second refresh frequency; or
(g) a first value of L determined by a first refresh frequency of the second CSI parameter being greater than a second value of L determined by a second refresh frequency of the second CSI parameter, wherein the first refresh frequency is less than the second refresh frequency.

13. An apparatus for wireless communication comprising a processor, configured to implement the method recited in claim 1.

14. A non-transitory computer readable program storage medium having code stored thereon, the code, when executed by a processor, causing the processor to implement the method recited in claim 1.

15. The method of claim 2, wherein, when a number of layers supported by the wireless device is greater than 1, each column of the precoding matrix that corresponds to one layer is (a) a weighted combination of a same set of vectors or (b) a weighted combination of a respective set of vectors corresponding to the one layer.

16. The method of claim 6, wherein the first CSI parameter is reported in a first part of a CSI report and the second CSI parameter is reported in a second part of the CSI report.

17. The method of claim 11, wherein the mapping between the first CSI parameter and the second CSI parameter based on the rule comprises at least one of:
(a) a predetermined mapping table between multiple values of the first CSI parameter and multiple values of the second CSI parameter;
(b) a first value of the codebook type selection parameter of the first CSI parameter associated with a first value of the second CSI parameter determining a codebook to be a Type II codebook, and a second value of the codebook type selection parameter of the first CSI parameter associated with a second value of the second CSI parameter determining the codebook to be a Type I codebook, wherein the first value of the second CSI parameter is greater than the second value of the second CSI parameter;
(c) a first value of L of the first CSI parameter associated with a first value of the second CSI parameter being greater than a second value of L of the first CSI parameter associated with a second value of the second CSI parameter, wherein the first value of the second CSI parameter is greater than the second value of the second CSI parameter;
(d) a first number of available groups of base vectors associated with the second CSI parameter determining a codebook to be a Type II codebook and a second number of available groups of base vectors associated with the second CSI parameter determining the codebook to be a Type I codebook, wherein the first number is less than the second number;
(e) a first value of L determined by the first number of available groups of base vectors associated with the second CSI parameter being greater than a second value of L determined by the second number of available groups of base vectors associated with the second CSI parameter, wherein the first value is less than the second value;
(f) a first refresh frequency of the second CSI parameter determining a codebook to be a Type II codebook and a second refresh frequency of the second CSI parameter determining the codebook to be a Type I codebook, wherein the first refresh frequency is less than the second refresh frequency; or
(g) a first value of L determined by a first refresh frequency of the second CSI parameter being greater than a second value of L determined by a second refresh frequency of the second CSI parameter, wherein the first refresh frequency is less than the second refresh frequency.

18. An apparatus for wireless communication comprising a processor, configured to implement the method recited in claim 8.

19. An apparatus for wireless communication comprising a processor, configured to implement the method recited in claim 10.

20. A non-transitory computer readable program storage medium having code stored thereon, the code, when executed by a processor, causing the processor to implement the method recited in claim 8.
